(19) United States
(12) Patent Application Publication
(10) Pub. No.: US 2010/0326231 A1
(43) Pub. Date: Dec. 30, 2010

(54) Protection sheath for bicycle operation cables

(76) Inventor: Yung-Pin Kuo, Chang Hwa City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/585,164

(22) Filed: Sep. 8, 2009

(30) Foreign Application Priority Data
Jun. 24, 2009 (TW) 098211362

(51) Int. Cl. F16C 1/26

(52) U.S. Cl. 74/502.5

(57) ABSTRACT

A bicycle operation cable sheath includes an inner hose which extends through a flexible sheath which is composed of multiple first parts and second parts. The first and second parts are made by different materials. Two first curved surfaces are defined in two respective inner peripheries of two opening made by the first passage of each first part so that the second parts are rotatably engaged with the two first curved surfaces of the two adjacent first parts. Two second pieces are respectively connected to two ends of the flexible sheath and the inner hose includes a flange at one end thereof and the flange is engaged with an engaging surface defined in one end of one of the two end pieces.

### FIELD OF THE INVENTION

The present invention relates to a cable sheath, and more particularly, to a bicycle operation cable sheath which is easily assembled and flexible in all directions.

### BACKGROUND OF THE INVENTION

A conventional bicycle cable sheath 60 is shown in FIGS. 6 and 7, and generally includes multiple first parts 61 and each first part 61 includes a passage 63 defined axially therethrough and two flat surfaces 611 are defined in the first end thereof. Two protrusions 612 extend radially from the two flat surfaces 611 and two extensions 613 extend axially from the second end of each first part 61. Each extension 613 includes a hole 614 defined therethrough. The first parts 61 are connected to each other to form an elongate sheath by pivotably engaging the two protrusions 612 of one first part 61 with the holes 614 of the extensions 613 of the next first part 61. Two second parts 62 are connected to two ends of the elongate sheath 60 by the similar structure as the connection between the first parts 61. The operation cable 4 extends through the passages 63 of the second parts 62 and the first parts 61. The adjacent first parts 61 are pivotable about the protrusions 612 so as to meet the requirement that the operation cable 4 requires.

It is noted that the connection between the first parts 61 and between the first and second parts 61, 62 requires a lot of time to aim the holes 614 with the protrusions 612 one by one. Furthermore, the first parts 61 include a complicated shape which makes the mold to manufacture the first parts 61 be difficult and expensive.

The present invention intends to provide a flexible operation cable sheath which is easily assembled and manufactured.

### SUMMARY OF THE INVENTION

The present invention relates to a bicycle operation cable sheath and comprises a flexible inner hose which includes a first end and a second end, the first end of the inner hose includes a flange extending radially therefrom. A flexible sheath includes multiple first parts and second parts which are connected to the first parts alternatively. The first and second parts are made by different materials. Each first part includes a first passage and each second part includes a second passage defined axially therethrough. The inner hose extends through the first and second passages. Two first curved surfaces are defined in two respective inner peripheries of two opening made by the first passage of each first part. The second parts are rotatably engaged with the two first curved surfaces of the two adjacent first parts. Two second pieces are respectively connected to two ends of the flexible sheath and each include a third passage defined axially therethrough. One of the two end pieces includes an engaging surface defined in an end thereof and the flange of the inner hose is engaged with the engaging surface.

The primary object of the present invention is to provide a bicycle operation cable sheath which is easily assembled and manufactured.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the cable sheath of the present invention;

FIG. 2 is an exploded view to show a portion of the cable sheath of the present invention;

FIG. 3 is a cross sectional view of the cable sheath of the present invention;

FIG. 4 is a cross sectional view of another embodiment of the cable sheath of the present invention;

FIG. 4a is a cross sectional view of yet another embodiment of the cable sheath of the present invention;

FIG. 5 shows that the operation cable is connected to a bicycle derailleur system;

FIG. 6 is an exploded view to show a conventional cable sheath, and

FIG. 7 shows the connection of the first and second parts of the conventional cable sheath.

### DETAILED DESCRIPTION OF THE PREFERRED EMBODIMENT

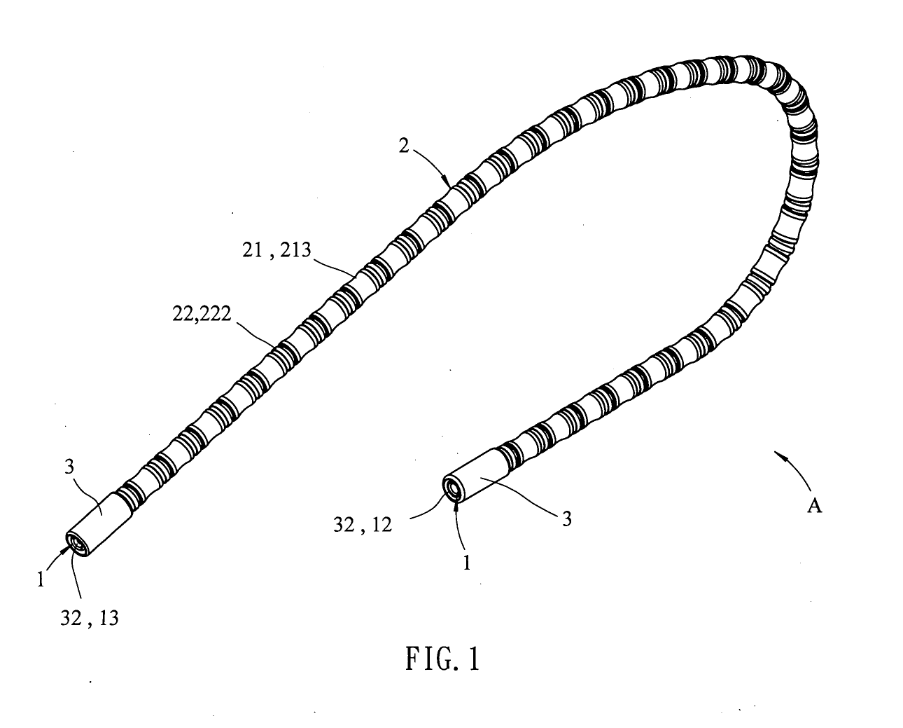

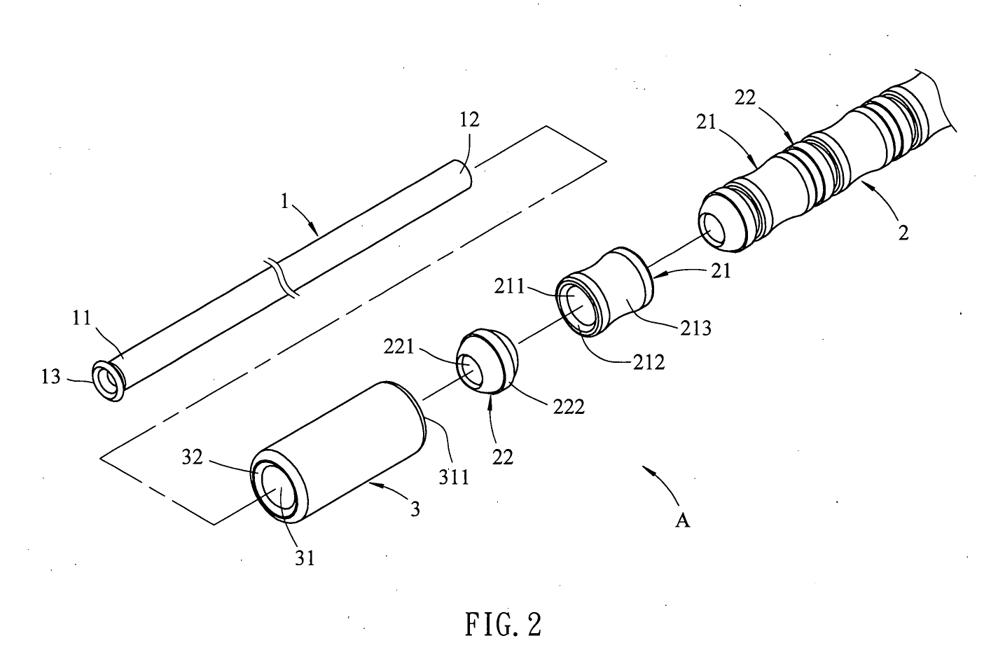

Referring to FIGS. 1 to 3; the bicycle operation cable sheath of the present invention comprises an inner hose 1 which is a flexible hose and includes a first end 11 and a second end 12. The first end 11 of the inner hose 1 includes a flange 13 extending radially therefrom.

A flexible sheath 2 is composed of multiple first parts 21 and second parts 22 which are connected to the first parts 21 alternatively. The first and second parts 21, 22 are made by different materials. The first parts 21 are made by metallic material and the second parts 22 are made by non-metallic material, or the first parts 21 are made by non-metallic material and the second parts 22 are made by metallic material. The metallic material can be aluminum alloy and the non-metallic material can be plastic.

Each first part 21 includes a first passage 211 and each second part 22 including a second passage 221 defined axially therethrough. The inner hose 1 extends through the first and second passages 211, 221. Two first curved surfaces 212 are defined in two respective inner peripheries of two opening made by the first passage 211 of each first part 21. The second parts 22, in this embodiment, are spherical parts and rotatably engaged with the two first curved surfaces 212 of the two adjacent first parts 21.

Two end pieces 3 are respectively connected to two ends of the flexible sheath 2 and each of the end pieces 3 includes a third passage 31 defined axially therethrough. One of the two end pieces 3 includes an engaging surface 32 defined in a first end thereof and the flange 13 of the inner hose 1 is engaged with the engaging surface 32.

It is noted that the inner diameter of the second passage 221 of each of the second parts 22 is substantially the same as the outer diameter of the inner hose 1, and the inner diameter of the first passage 211 of each of the first parts 21 is larger than the inner diameter of each of the second passages 221. Each of the second parts 22 includes an annular ridge 222 extending radially from an outer periphery thereof and each of the first parts 21 includes an annular groove 213 defined radially in an outer periphery thereof. The ridges 222 and the grooves 213 provide the flexible sheath 2 an attractive outer appearance. The different materials for the first and second parts 21, 22 reduce the cost of manufacturing.

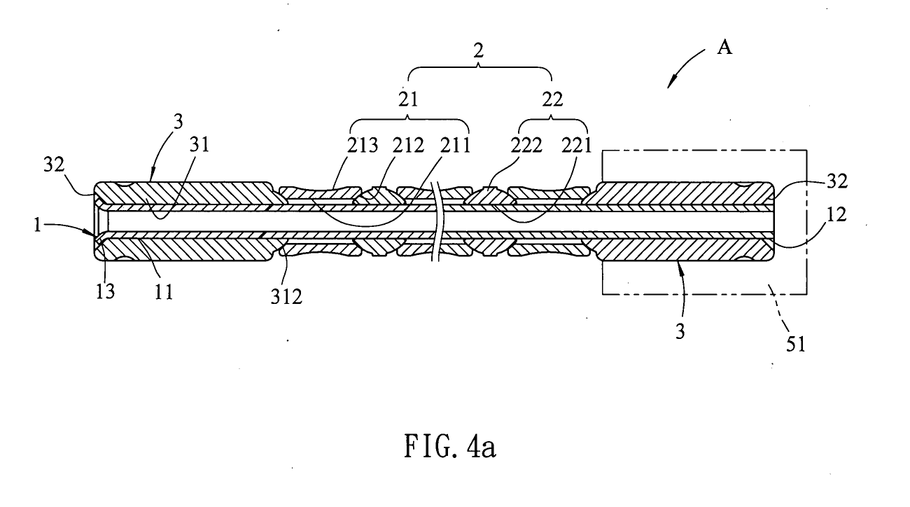

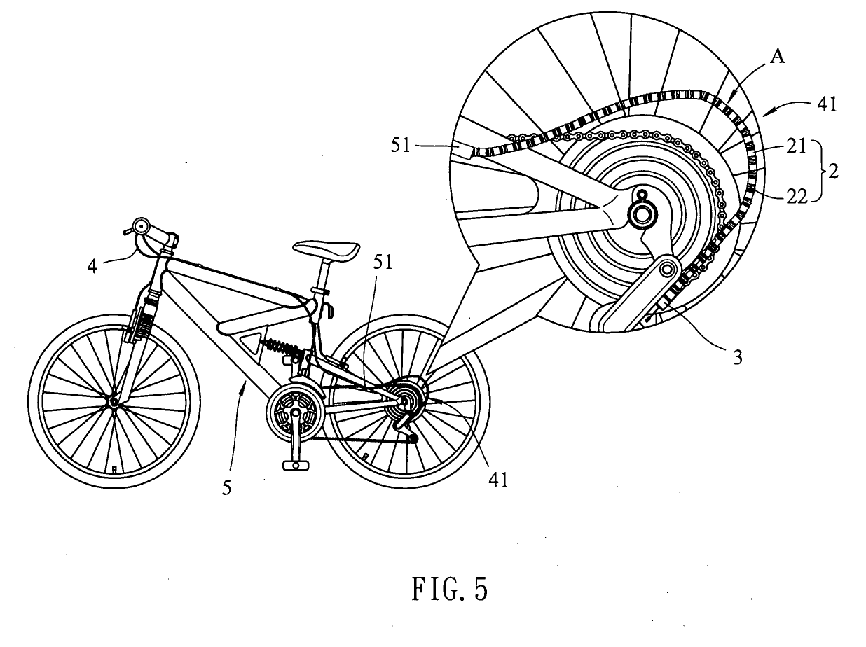

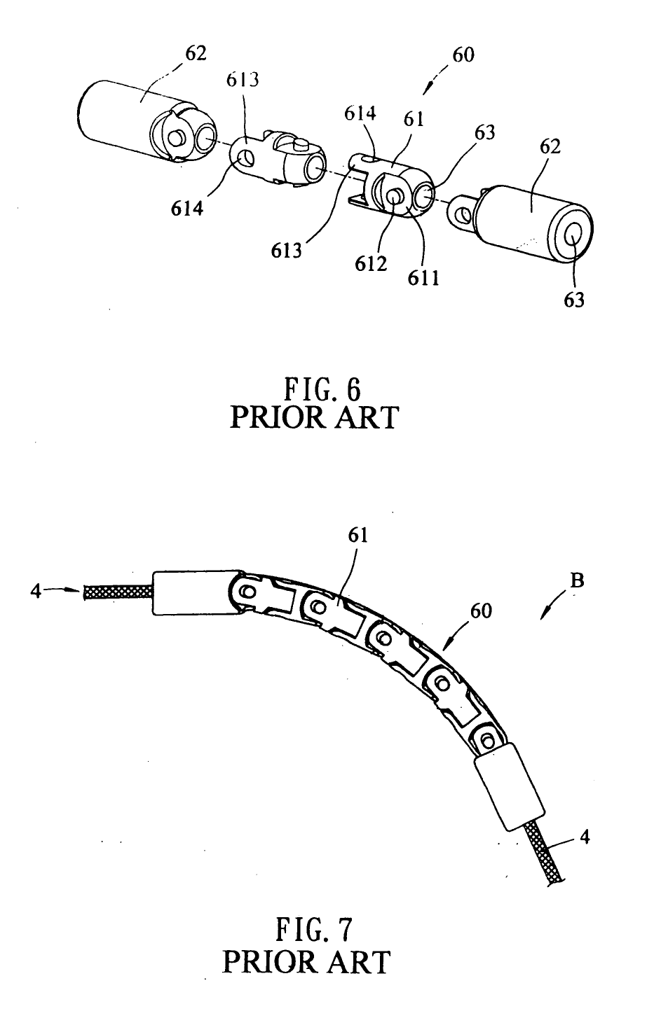

As shown in FIG. 5, the operation cable 4 extends through the inner hose 1 and has one end connected to the shifter of the derailleur system and the flexible sheath 2 extends through the positioning member 51 on the bicycle frame 5 and the second end of the operation cable 4 is connected to the related parts of the derailleur system. Of course, the present invention can also be applied to the brake cables of brake system for bicycles.

The spherical second parts 22 can be pivoted relative to the first parts 21 in every direction so that the flexible sheath 2 can be easily connected to the bicycle without worry of bending as represented by numeral 41 in FIG. 5.

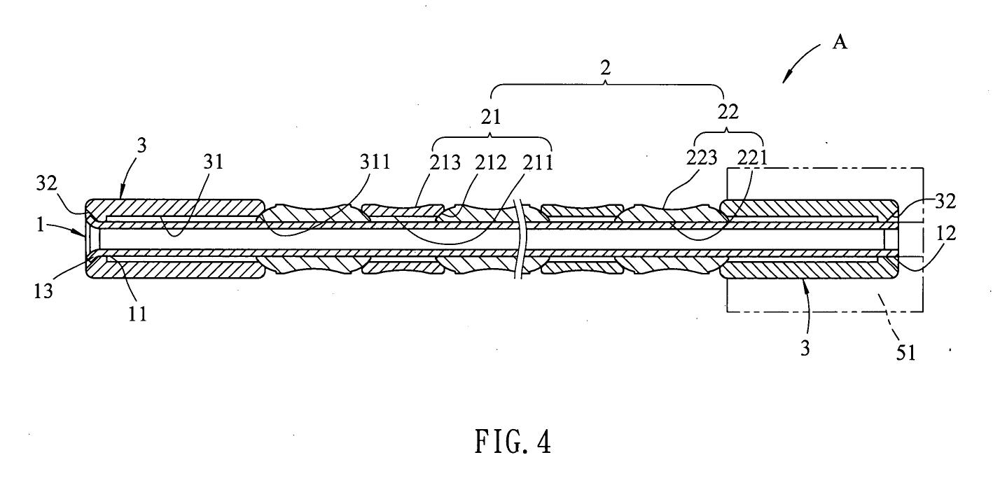

FIG. 4 shows another embodiment, wherein the second parts 22 are oval parts and each end piece 3 includes a curved recess 311 defined in a second end thereof so that the end of the oval second part 22 can be matched with the curved recess 311. Each of the second parts 22 includes an annular groove 223 defined radially in an outer periphery thereof.

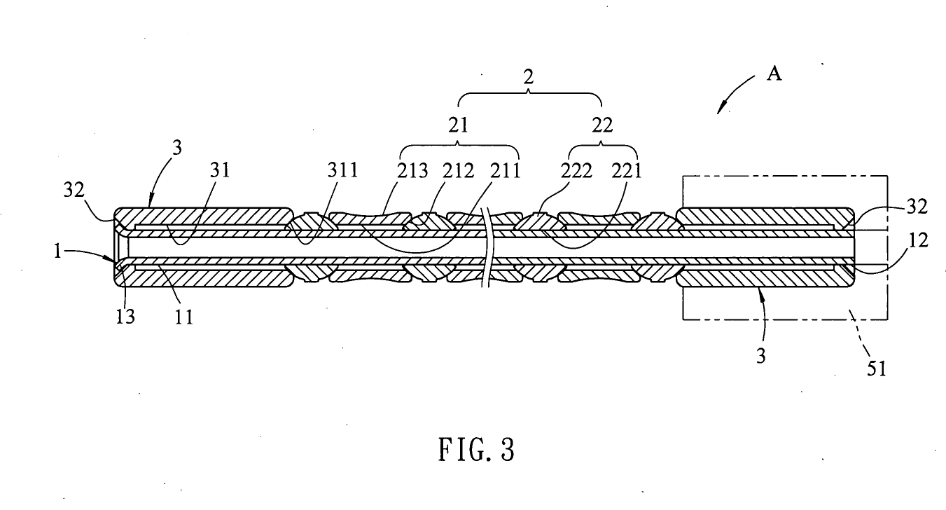

FIG. 4a shows yet another embodiment, wherein the second end of each end piece 3 includes a protrusion 312 which extends longitudinally therefrom and the protrusion 312 includes a curved outer surface. The first curved surface 212 of the first part 21 is mounted to the curved outer surface of the protrusion 312. In other words, the second end of the end piece 3 may have the curved recess 311 as shown in FIG. 3 to be engaged with the spherical second part 22, or the cured recess 311 as shown in FIG. 4 so as to be engaged with the oval second part 22, or the protrusion 312 as shown in FIG. 4a to be engaged with the curved surface 212 of the first part 21.

While we have shown and described the embodiment in accordance with the present invention, it should be clear to those skilled in the art that further embodiments may be made without departing from the scope of the present invention.

What is claimed is:

1. A bicycle operation cable sheath comprising:
an inner hose which is a flexible hose and includes a first end and a second end, the first end of the inner hose including a flange extending radially therefrom;
a flexible sheath including multiple first parts and second parts which are connected to the first parts alternatively, the first and second parts being made by different materials and each first part including a first passage and each second part including a second passage defined axially therethrough, the inner hose extending through the first and second passages, two first curved surfaces defined in two respective inner peripheries of two opening made by the first passage of each first part, the second parts rotatably engaged with the two first curved surfaces of the two adjacent first parts, and
two end pieces respectively connected to two ends of the flexible sheath and each including a third passage defined axially therethrough, a first end of each end piece including an engaging surface and the flange of the inner hose engaged with the engaging surface of one of the end pieces.

2. The sheath as claimed in claim 1, wherein a second end of at least one of the two end pieces includes a curved recess and the second part is connected to the curved recess of one of the end pieces.

3. The sheath as claimed in claim 1, wherein a second end of at least one of the two end pieces includes a protrusion extending longitudinally therefrom and the protrusion includes a curved outer surface, the first curved surface of the first part is mounted to the curved outer surface of the protrusion.

4. The sheath as claimed in claim 1, wherein the first parts are made by metallic material and the second parts are made by non-metallic material.

5. The sheath as claimed in claim 1, wherein the first parts are made by non-metallic material and the second parts are made by metallic material.

6. The sheath as claimed in claim 4, wherein the first parts are made by aluminum alloy and the second parts are made by plastic.

7. The sheath as claimed in claim 5, wherein the first parts are made by plastic and the second parts are made by aluminum alloy.

8. The sheath as claimed in claim 1, wherein an inner diameter of the second passage of each of the second parts is substantially the same as an outer diameter of the inner hose, an inner diameter of the first passage of each of the first parts is larger than the inner diameter of each of the second passages,

9. The sheath as claimed in claim 1, wherein each of the second parts is spherical or oval part.

10. The sheath as claimed in claim 1, wherein each of the second parts includes an annular ridge extending radially from an outer periphery thereof.

11. The sheath as claimed in claim 1, wherein each of the second parts includes an annular groove defined radially in an outer periphery thereof.

12. The sheath as claimed in claim 1, wherein each of the first parts includes an annular groove defined radially in an outer periphery thereof.
